(19) United States
(12) Patent Application Publication
(10) Pub. No.: US 2011/0101075 A1
(43) Pub. Date: May 5, 2011

(54) Apparatus and methods of attaching hybrid vlsi chips to printed wiring boards

(75) Inventor: Deepak K. Pai, Burnsville, MN (US)

(73) Assignee: General Dynamics Advanced Information Systems, Fairfax, VA (US)

(21) Appl. No.: 12/929,224

(22) Filed: Jan. 10, 2011

Related U.S. Application Data
(63) Continuation of application No. 12/379,524, filed on Feb. 24, 2009.
(60) Provisional application No. 61/064,337, filed on Feb. 28, 2008.

(51) Int. Cl. B23K 31/12; B23K 31/02; B23K 1/20

(52) U.S. Cl. 228/103; 228/155

(57) ABSTRACT

A method for preparing an integrated circuit for connection to a surface, the integrated circuit including lead contacts and leadless contacts, is provided. The method includes providing the integrated circuit, applying a first solder paste to the leadless contacts, forming solder balls on the applied solder paste, heating the solder balls, thereby removing at least a portion of the first solder paste and bringing the solder balls into electrical contact with the leadless contacts, the base of the solder balls being generally aligned in a plane, and bending the lead contacts into gull wings, with the base of the gull wings being substantially coplanar with the plane. The base of the gull wings and the base of the at least one of the solder balls collectively generally define a contact plane for potential future contact with the surface.

### CROSS REFERENCE TO RELATED APPLICATIONS

The instant application claims priority to U.S. Provisional Application 61/064,337 filed on Feb. 28, 2008, the disclosure of which is expressly incorporated herein in its entirety.

### BACKGROUND OF THE INVENTION

1. Field of the Invention

The present invention relates to a connection methodology. More specifically, the present invention relates to methodologies for connecting hybrid chips to printed wiring boards where the chips contain both leads and leadless contacts.

2. Discussion of Background Information

An integrated circuit (“IC”) typically comes in two varieties. One variety includes ICs with metal leads extending therefrom that carry power, ground, input and output signal. The metal leads are often rigid and bent into a shape known as a “gull wing.” The other variety uses “leadless” contacts, in which conductive pads are integrated into the surface of the IC. Varieties of methods are known for connecting the leads, leaded ICs, or conductive pads of leadless ICs to printed circuit boards.

Recently a hybrid chip has been introduced that utilizes both gull wing leads and leadless contact pads on the bottom of the chip. FIGS. 1A-1C show an example of such a hybrid chip 102. It is difficult to mount hybrid chip 102 to a printed circuit board, as known connection methodologies for the gull wing and the leadless pads can conflict with each other.

### SUMMARY OF THE INVENTION

According to an embodiment of the invention, a method for preparing an integrated circuit for connection to a surface, the integrated circuit including lead contacts and leadless contacts, is provided. The method includes providing the integrated circuit, applying a first solder paste to the leadless contacts, forming solder balls on the applied solder paste, heating the solder balls, thereby removing at least a portion of the first solder paste and bringing the solder balls into electrical contact with the leadless contacts, the base of the solder balls being generally aligned in a plane, and bending the lead contacts into gull wings, the base of the gull wings being substantially coplanar with the plane, wherein the base of the gull wings and the base of the at least one of the solder balls collectively generally define a contact plane.

The above embodiment may include various features. The method may include: determining, before the bending and after the heating, a lateral distance between the lead contacts and the base of at least one of the solder balls; and/or electrically connecting the lead contacts and leadless contacts to the surface. The electrically connecting may include applying a second solder paste to the surface, soldering the base of the gull wings to the surface, and heating the solder balls, thereby removing at least a portion of the second solder paste and bringing the solder balls into electrical contact with the surface, wherein the integrated circuit will be in electrical contact with the surface through both the leadless contacts and the lead contacts. The providing the integrated circuit may include providing an integrated circuit with the lead contacts attached to the body of the integrated circuit and extending laterally away from the body. The forming solder balls may include forming solder balls of about 10 mils in diameter and/or forming solder balls of substantially equal size.

According to another embodiment of the invention, a method for preparing an integrated circuit for connection to a surface, the integrated circuit including lead contacts and leadless contacts, is provided. The method includes providing the integrated circuit, applying a first solder paste to the leadless contacts, connecting bent leads to the applied solder paste, soldering the bent leads, thereby removing at least a portion of the first solder paste and bringing the bent leads into electrical contact with the leadless contacts, the base of the bent leads being generally aligned in a plane, and bending the lead contacts into gull wings, the base of the gull wings being substantially coplanar with the plane, wherein the base of the gull wings and the base of the at least one of the bent leads collectively generally define a contact plane.

The above embodiment may have various features. The method may include: determining, before the bending and after the soldering, a lateral distance between the lead contacts and the base of at least one of the bent leads; and/or electrically connecting the lead contacts and leadless contacts to the surface. The electrically connecting may include applying a second solder paste to the surface, soldering the base of the gull wings and the base of the bent leads to the surface, thereby removing at least a portion of the second solder paste and bringing the bent leads into electrical contact with the surface, wherein the integrated circuit will be in electrical contact with the surface through both the leadless contacts and the lead contacts. The providing the integrated circuit may include providing an integrated circuit with the lead contacts attached to the body of the integrated circuit and extending laterally away from the body. The bent leads may be either S-leads or C-leads. The connecting may include providing the bent leads on a fixture, and orientating the fixture to bring the bent leads into alignment with the leadless contacts; the bent leads made be removed from the fixture after the bent leads are connected to the integrated circuit.

According to yet another embodiment of the invention, a method for preparing an integrated circuit for connection to a surface, the integrated circuit including lead contacts and leadless contacts, is provided. The method includes providing the integrated circuit, applying a conductive epoxy to the leadless contacts, the base of the epoxy being generally aligned in a plane, and bending the lead contacts into gull wings, the base of the gull wings being substantially coplanar with the plane, wherein the base of the gull wings and the base of the at least one of the bent leads collectively generally define a contact plane.

The above embodiment may include various optional features. The method may include: determining, before the bending and after the applying, a lateral distance between the lead contacts and the base of at least one of the bent leads; and/or electrically connecting the lead contacts and leadless contacts to the surface. The electrically connecting may include applying a second solder paste to the surface, soldering the base of the gull wings to the surface, curing the conductive epoxy, wherein the integrated circuit will be in electrical contact with the surface through both the leadless contacts and the lead contacts. The providing the integrated circuit may include providing an integrated circuit with the lead contacts attached to the body of the integrated circuit and extending laterally away from the body.

According to still yet another embodiment of the invention, a method for preparing an integrated circuit for connection to a surface, the integrated circuit including lead contacts and leadless contacts, is provided. The method includes providing the integrated circuit, applying a first solder paste to the leadless contacts, placing preformed conductive metal pieces on the first solder paste, soldering the metal pieces, thereby removing at least a portion of the first solder paste and bringing the metal pieces into electrical contact with the leadless contacts, the base of the metal pieces being generally aligned in a plane, and bending the lead contacts into gull wings, the base of the gull wings being substantially coplanar with the plane, wherein the base of the gull wings and the base of the at least one of the metal pieces collectively generally define a contact plane.

The above embodiment may have various optional features. The method may include: determining, before the bending and after the soldering, a lateral distance between the lead contacts and the base of at least one of the metal pieces; and/or electrically connecting the lead contacts and leadless contacts to the surface. The electrically connecting may include applying a second solder paste to the surface, soldering the base of the gull wings and the metal pieces to the surface, wherein the integrated circuit will be in electrical contact with the surface through both the leadless contacts and the lead contacts. The providing the integrated circuit may include providing an integrated circuit with the lead contacts attached to the body of the integrated circuit and extending laterally away from the body.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, as follows.

FIGS. 1A-1C are top, side and bottom views of a hybrid integrated circuit with leads and leadless contacts in which the leads have been bent into gull wings.

FIG. 2 is a side view of the steps of an embodiment of the invention for attaching a hybrid chip to a printed wiring board.

FIG. 3 is a flow chart of the process steps of FIG. 2.

FIG. 4 is a side view of the steps of an embodiment of the invention for attaching a hybrid chip to a printed wiring board.

FIG. 5 is a flow chart of the process steps of FIG. 4.

FIG. 6 is a side view of the steps of an embodiment of the invention for attaching a hybrid chip to a printed wiring board.

FIG. 7 is a flow chart of the process steps of FIG. 6.

FIG. 8 is a side view of the steps of an embodiment of the invention for attaching a hybrid chip to a printed wiring board.

FIG. 9 is a flow chart of the process steps of FIG. 8.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

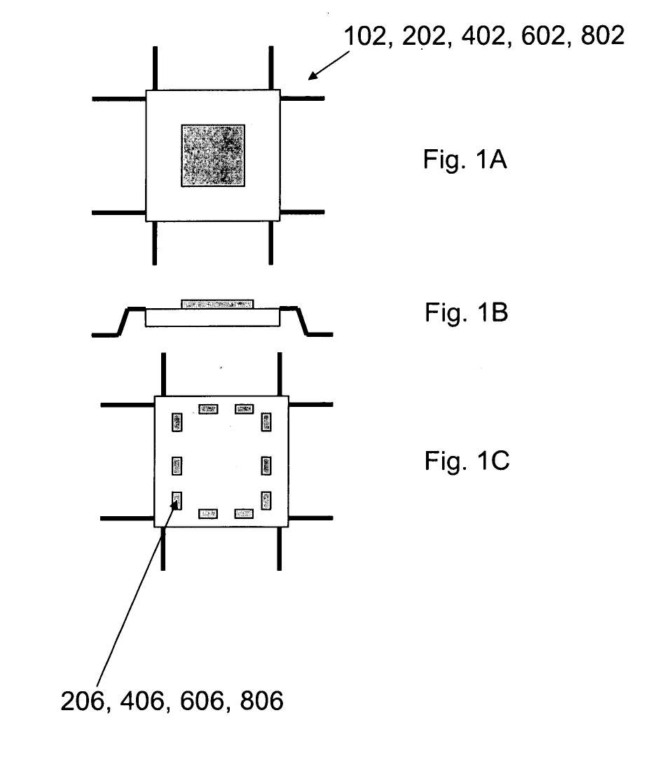

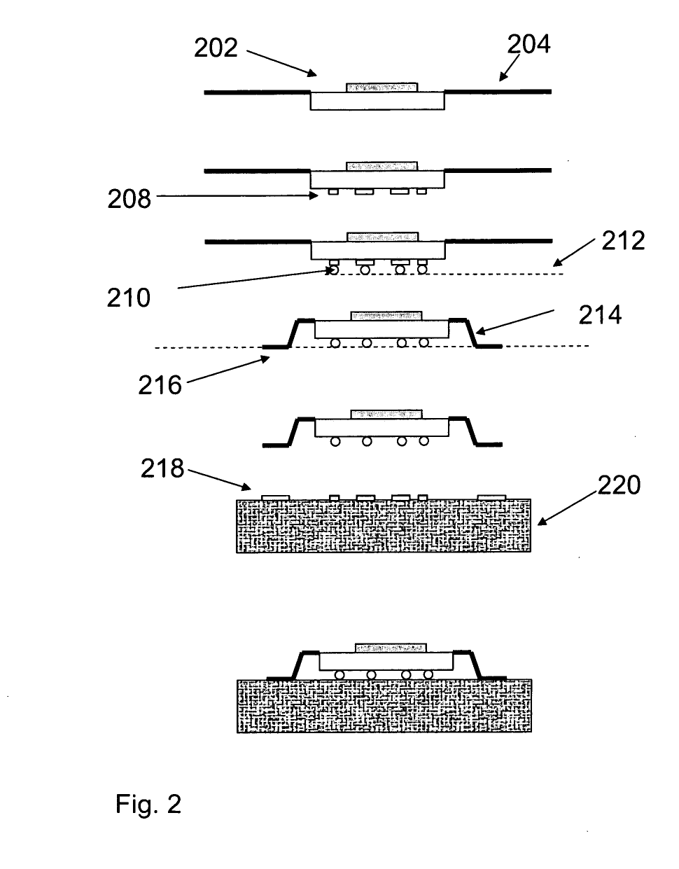

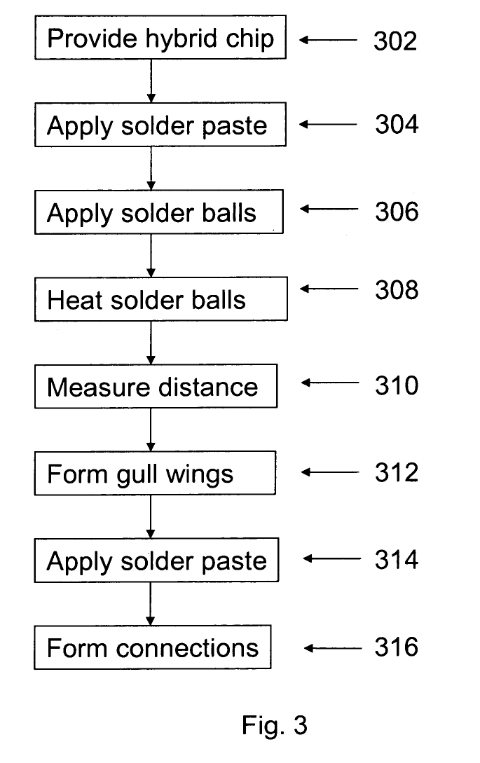

Referring now to FIGS. 2 and 3, a methodology for attaching a hybrid chip 202 is shown. At step 302, a hybrid chip 202 is provided that includes a plurality of leads 204 in a first orientation and a plurality of contact pads 206 (FIG. 1C). The initial orientation (for this embodiment and the later embodiments below) is preferably a connection to the body of chip 202 and extending laterally away from chip 202 without bends. However, other initial orientations may be used.

Solder paste 208 (thickness exaggerated for illustration) is applied to conductive contact pads 206 at step 304. At step 306, solder balls 210 are then applied on top of solder paste 208. The solder balls 210 are then heated to bond with conductive pads 206 at step 308; this tends to remove solder paste 208, such that it is no longer shown in FIG. 2.

Each solder ball 210 is preferably about 10 mils in diameter when deposited, although they are expected to expand as solder flows during soldering. Each solder ball 210 is preferably made from a material with a melting point of 290 degrees or above. Pure copper or a 10/90 alloy of tin and lead are suitable for this environment.

The lower surface of the solder balls 210 will roughly define a base plane 212 at which the solder balls 210 will later connect to a printed wiring board. At step 310 the distance between that plane and leads 204 is then determined, and at step 312 the leads 204 are bent into a second orientation that includes gull wings 214. The lateral wing portions 216 of gull wings 214 lie in the base plane 212, thus forming a collective contact plane.

At step 314, solder paste 218 is applied using a stencil at the appropriate locations on a printed wiring board 220. At step 316, wings 214 are then soldered onto their respective portions of solder paste 218, while the solder balls 210 are heated to form connections onto the printed circuit board 220. The connections at step 316 can be simultaneously or in any order.

Solder balls 210 tend to have minimal compliancy and tend to crack under stress. The connections of FIG. 2 are thus preferable for environments with minimal thermal expansion and/or minimal thermal expansion cycles.

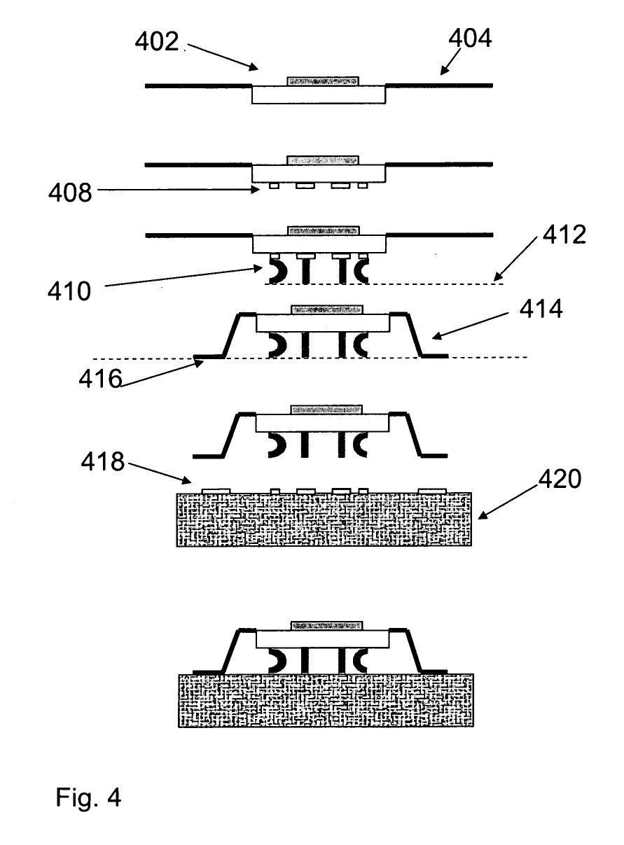

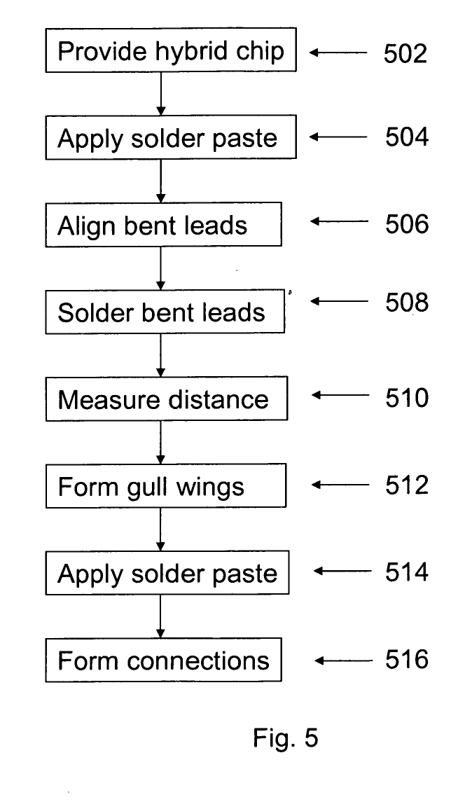

FIGS. 4 and 5 show another embodiment of the invention. At step 502, a hybrid chip 402 is provided that includes a plurality of leads 404 in a first orientation and a plurality of contact pads 406 (as in FIG. 1C). Solder paste 408 (thickness exaggerated for illustration) is applied to contact pads 406 at step 504. At step 506, a plurality of pre-bent conductive leads 410, such as copper alloy C-leads or S-leads, are then secured in fixtures and pressed against solder paste 408. Solder is then applied to connect the bent leads 410 to pads 406 at step 508. Once bent leads 410 are attached, the connection to the securing fixture can be removed.

Each bent lead is preferable 0.40 mils high, and made from a copper alloy. In the alternative, small form factor bent leads of the type shown in co-pending U.S. patent application Ser. No. 11/979,487 (filed on Nov. 7, 2007, the disclosure of which is herein incorporated by reference in its entirety) can be used.

The lower portion of the connected bent leads will roughly define a base plane 412 at which the bent leads 410 will later contact the printed wiring board. At step 510 the distance between that plane and leads 404 is then determined, and at step 512 the leads 404 are bent into a second orientation that includes gull wings 414. The wing portions 416 of gull wings 414 lie in the base plane 412, thus forming a collective contact plane.

At step 514, solder paste 418 is applied using a stencil at the appropriate locations on a printed wiring board 420. At step 516, wings 414 and leads 410 are then soldered onto their respective portions of solder paste 218. The connections at step 516 can be made simultaneously or in any order.

Bent leads have a compliancy that allows them to shift during thermal stress. This makes the connection of FIG. 4 particularly useful for harsh environments subject to considerable thermal expansion and/or repeating thermal expansion cycles.

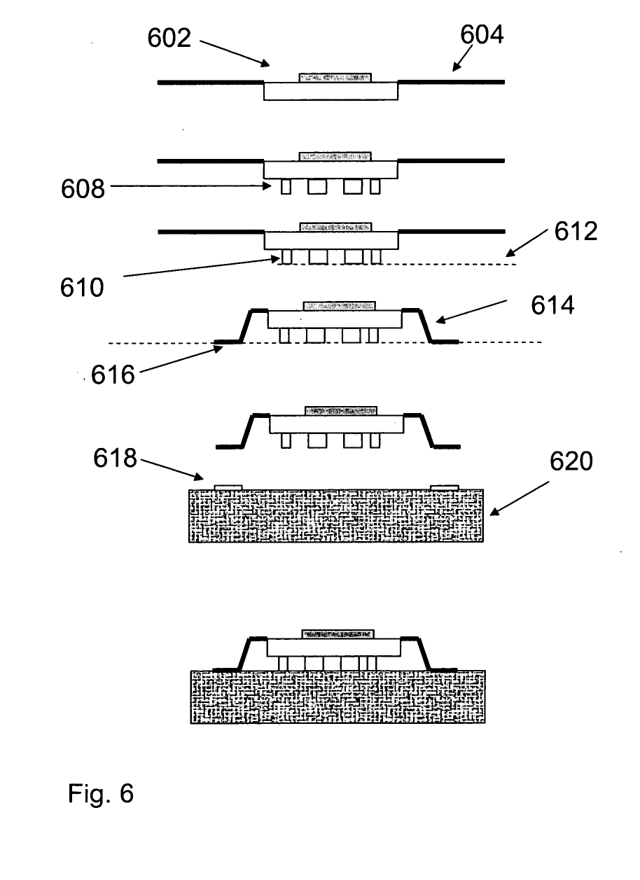

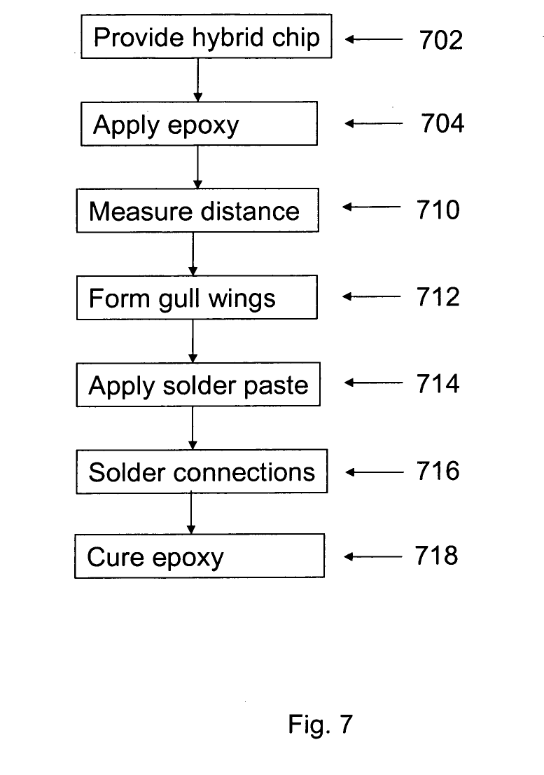

FIGS. 6 and 7 show another embodiment of the invention. At step 702, a hybrid chip 602 is provided that includes a plurality of leads 604 in an initial orientation and a plurality of contact pads 606 (as in FIG. 1C). Conductive epoxy 608 is applied to contact pads 606 at step 704. The lower portion of the epoxy will roughly define a base plane 612 at which the epoxy 608 will later contact the printed wiring board. At step 710 the distance between that plane and leads 604 is then determined, and at step 712 the leads 604 are bent into a second orientation that includes gull wings 614. The wing portions 616 of gull wings 614 lie in the base plane 612, thus forming a collective contact plane.

At step 714, solder paste 618 is applied using a stencil at the appropriate locations on a printed wiring board 420 that correspond to the contact points for wing portions 616. At step 716, wings 614 are soldered onto their respective portions of solder paste 618. At step 718, the epoxy is cured. The connections at steps 716 and 718 can be made simultaneously or in any order.

Conductive epoxy is more compliant than solder but less compliant than bent leads. It is thus suitable for use in environments with moderate to high thermal expansion and/or cycles of thermal expansions, although not to the same extent as bent leads. Thus, for example, this connection methodology is not preferable for avionics applications.

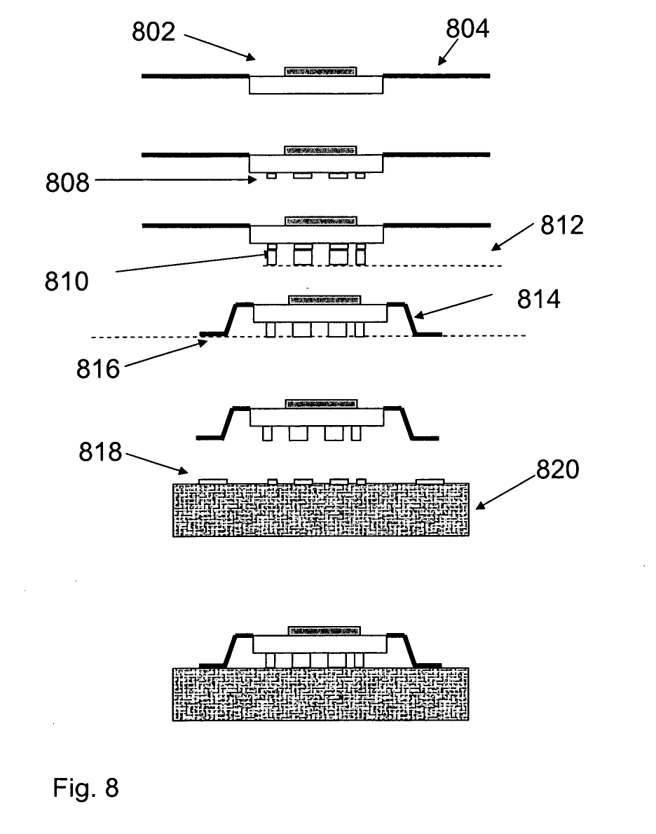

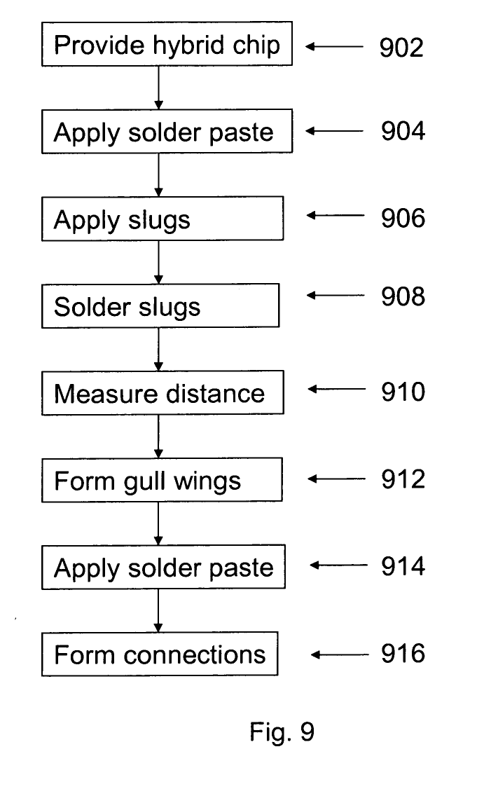

Referring now to FIGS. 8 and 9, another methodology for attaching a hybrid chip 202 is shown. At step 902, a hybrid chip 802 is provided that includes a plurality of leads 804 in an initial orientation and a plurality of contact pads 806 (FIG. 1C). Solder paste 808 (thickness exaggerated for illustration) is applied to contact pads 806 at step 904. At step 906, pre-slugs of conductive metal 810 are then applied on top of solder paste 808. Solder is applied at step 908; this tends to remove the solder paste, such that it is no longer shown in FIG. 8.

Each slug 810 is preferably about 5 mils in height, although other heights could be used. FIG. 8 shows slug 810 as rectangular, but other shapes, such as cylindrical, could be used. Each slug 810 is preferably made from a material with a higher melting point than the solder. A copper alloy with a sufficiently high melting point so as not to melt during the soldering process is sufficient for this.

The lower portion of the slugs 810 will roughly define a base plane 812 at which the slugs 810 will contact the printed wiring board. At step 910 the distance between that plane and leads 804 is then determined, and at step 912 the leads 804 are bent into a second orientation that includes gull wings 814. The wing portions 816 of gull wings 814 lie in the base plane 812, thus forming a collective contact plane.

At step 914, solder paste 818 is applied using a stencil at the appropriate locations on a printed wiring board 820. At step 916, wings 814 are then soldered onto their respective portions of solder paste 818, while the slugs 810 are heated to form connections onto the printed circuit board 820. The connections at step 916 can be made simultaneously or in any order.

It is noted that the foregoing examples have been provided merely for the purpose of explanation and are in no way to be construed as limiting of the present invention. While the present invention has been described with reference to certain embodiments, it is understood that the words that have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of any current or future claims.

Various claims below recite terms for which the following additional discussion may be relevant. For example:
“base” is a relative term generally referring to the lower ends of structures when in the orientation shown in FIG. 1.
“before” and “after” refer to the order of steps, but do not require (nor exclude) that the identified order of steps follow directly or indirectly via intervening steps.
“lead” is used in the context of a lead of a circuit a circuit, as opposed to the metal Pb. This does not require nor exclude that the lead may be made of Pb or include Pb.

1.-7. (canceled)

8. A method for preparing an integrated circuit for connection to a surface, the integrated circuit including lead contacts and leadless contacts, the method comprising:
providing the integrated circuit;
applying a first solder paste to the leadless contacts;
connecting bent leads to the applied solder paste;
soldering the bent leads, thereby removing at least a portion of the first solder paste and bringing the bent leads into electrical contact with the leadless contacts, the base of the bent leads being generally aligned in a plane; and
bending the lead contacts into gull wings, the base of the gull wings being substantially coplanar with the plane;
wherein the base of the gull wings and the base of the at least one of the bent leads collectively generally define a contact plane.

9. The method of claim 8, further comprising:
determining, before said bending and after said soldering, a lateral distance between the lead contacts and the base of at least one of the bent leads.

10. The method of claim 8, further comprising electrically connecting said lead contacts and leadless contacts to the surface.

11. The method of claim 10, said electrically connecting further comprising:
applying a second solder paste to the surface;
soldering the base of the gull wings and the base of the bent leads to the surface, thereby removing at least a portion of the second solder paste and bringing the bent leads into electrical contact with the surface;
wherein the integrated circuit will be in electrical contact with the surface through both the leadless contacts and the lead contacts.

12. The method of claim 8, wherein said providing the integrated circuit comprises providing an integrated circuit with the lead contacts attached to the body of the integrated circuit and extending laterally away from the body.

13. The method of claim 8, wherein the bent leads are either S-leads or C-leads.

14. The method of claim 8, wherein said connecting further comprises providing said bent leads on a fixture; and
orientating said fixture to bring the bent leads into alignment with the leadless contacts.

15. The method of claim 8, further comprising removing the bent leads from the fixture after the bent leads are connected to the integrated circuit.

16.-25. (canceled)
